(19) United States
(12) Patent Application Publication
(10) Pub. No.: US 2008/0217450 A1
(43) Pub. Date: Sep. 11, 2008

(54) Hand-held shredding device for paper or the like

(75) Inventors: Braden L. Jones, Phoenix, AZ (US); Chris Holman, Mesa, AZ (US)

Correspondence Address: VENABLE LLP, P.O. BOX 34385, WASHINGTON, DC, 20043-9998, US

(73) Assignee: Esselte Corporation, Melville, NY (US)

(21) Appl. No.: 12/073,761

(22) Filed: Mar. 10, 2008

Related U.S. Application Data
(60) Provisional application No. 60/905,588, filed on Mar. 8, 2007.

(51) Int. Cl. B02C 18/06

(52) U.S. Cl. 241/169

(57) ABSTRACT

A hand-held shredding device is provided including a housing sized and configured to be hand-held. The housing may include a first opening configured to receive an object to be shredded and a second opening configured to allow the object to exit the housing upon being shredded. A shredding assembly may be disposed within the housing. The shredding assembly may include a first plurality of blades disposed on a first rotatable shaft and a second plurality of blades disposed on a second rotatable shaft. The first and second rotatable shafts may be coupled to one another through a geared connection. The first and second pluralities of blades may be arranged to cooperate with one another to shred the object. A hand-operable crank may be connected to an end of one of the first or second rotatable shafts of the shredding assembly. The hand-operable crank may be configured to be operable by a user's hand to rotate one of the first or second rotatable shafts and thereby provide power to the shredding assembly to contemporaneously shred the object while moving the object towards the second opening.

### CROSS-REFERENCE TO RELATED APPLICATIONS

This application is related to and claims the priority benefit of U.S. Provisional Patent Application No. 60/905,588, filed Mar. 8, 2007, the entirety of which is incorporated herein by reference.

### BACKGROUND

1. Field of the Invention

The present invention relates generally to shredding devices and more particularly to a hand-held shredder for paper or the like.

2. Related Art

Shredding devices are generally used to destroy paper documents or the like and thereby prevent the disclosure of confidential information. Most shredding devices on the market today are electric and/or battery operated and are typically sized and designed for home and/or office use such that they are not portable. Thus, students and business men and women who travel are often left without an efficient and effective way to destroy documents when away from the home or office.

### SUMMARY

According to an illustrative aspect of the invention, a hand-held shredding device is provided which may be low cost, portable, compact, light-weight, and/or manually operable. The hand-held shredding device may provide an effective and efficient way for a user to destroy paper documents or the like when not at home or in the office and thereby prevent disclosure of confidential information contained in such documents. The hand-held shredding device may, for example, be sized and designed to be stowed in a user's briefcase, backpack, bag, and/or carry-on luggage.

In an embodiment of the present invention a hand-held shredding device for paper documents or the like is provided. The hand-held shredding device may include a housing sized and configured to be hand-held. The housing may include a first opening configured to receive an object to be shredded and a second opening configured to allow the object to exit the housing upon being shredded. A shredding assembly may be disposed within the housing. The shredding assembly may include a first plurality of blades disposed on a first rotatable shaft and a second plurality of blades disposed on a second rotatable shaft. The first and second rotatable shafts may be coupled to one another through a geared connection and may also be arranged to cooperate with one another to shred the object. A hand-operable crank may be connected to an end of one of the first or second rotatable shafts of the shredding assembly. The hand-operable crank may be configured to be operable by a user's hand to rotate one of the first or second rotatable shafts and thereby provide power to the shredding assembly to contemporaneously shred the object while moving the object towards the second opening.

In another embodiment of the invention, the hand-held shredding device may further include a plurality of protrusions arranged along a periphery of the first opening to contact the object when the object is received in the first opening. The plurality of protrusions may be alternatingly arranged on opposite longitudinally extending edges of the first opening.

In still another embodiment, the hand-held shredding device may further include a plurality of guide elements extending towards the second opening to guide and support the object during shredding. The plurality of guide elements may be disposed adjacent to the first opening and extend substantially towards the second opening between the first and second rotatable shafts. Each of the plurality of guide elements may be positioned between two adjacent blades disposed on one of the first or second rotatable shafts. A second plurality of guide elements may be positioned adjacent to the second opening to guide the object towards the second opening after shredding. Each of the second plurality of guide elements may include an inclined surface arranged to guide the object towards the second opening after shredding.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of embodiments of the invention, as illustrated in the accompanying drawings wherein like reference numbers generally indicate identical, functionally similar, and/or structurally similar elements.

Unless otherwise indicated, the accompanying drawing figures are not to scale.

FIG. 1 depicts a perspective view of a hand-held shredding device according to an embodiment of the present invention;

FIG. 2 depicts the hand-held shredding device of FIG. 1 in use;

FIG. 3 depicts a top view of the hand-held shredding device of FIG. 1;

FIG. 4 depicts a bottom view of the hand-held shredding device of FIG. 1;

FIG. 5 depicts a front view of the hand-held shredding device of FIG. 1;

FIG. 6 depicts a side view of the hand-held shredding device of FIG. 1;

FIG. 7 depicts an exploded perspective view of the hand-held shredding device of FIG. 1;

FIG. 8 depicts an exploded perspective view of a hand-held shredding device according to another embodiment of the present invention;

FIG. 9 depicts a bottom perspective view of the hand-held shredding device of FIG. 1 with a bottom housing member removed to expose a shredding assembly disposed within the housing according to an embodiment of the present invention; and

FIG. 10 depicts a top perspective view of a bottom member of the housing according to an embodiment of the present invention.

### DETAILED DESCRIPTION

Various embodiments of the invention are discussed in detail below. While specific embodiments are discussed, specific terminology is employed for the sake of clarity. However, the invention is not intended to be limited to the specific terminology so selected and it should be understood that this is done for illustration purposes only. A person skilled in the relevant art will recognize that other components and configurations can be used without parting from the spirit and scope of the invention. Each specific element includes all technical equivalents that operate in a similar manner to accomplish a similar purpose.

In the following description of certain embodiments of the invention, directional words such as “top,” “bottom,” “upwardly,” and “downwardly” are employed by way of description and not limitation with respect to the orientation of the apparatus and its various components as illustrated in the drawings. Similarly, directional words such as “axial” and “radial” are also employed by way of description and not limitation.

### Example Definitions

In describing the invention, the following definitions are applicable throughout (including above).

The term “hand-held” may refer to something that is small enough or compact enough to be used or operated while being held in a hand or hands of a user.

### Detailed Description of an Embodiment

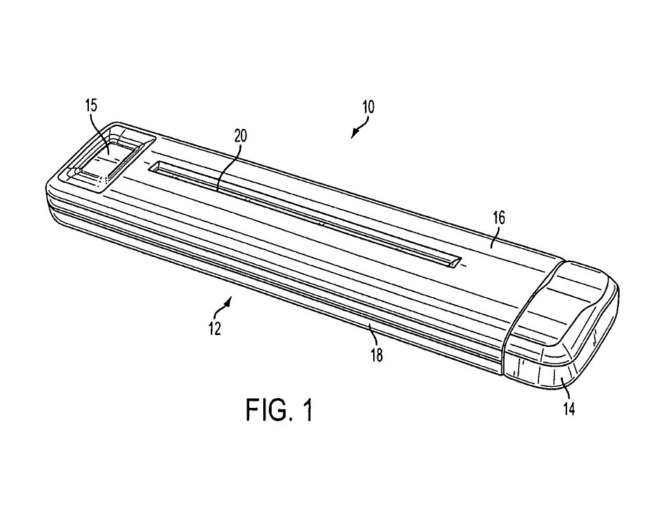

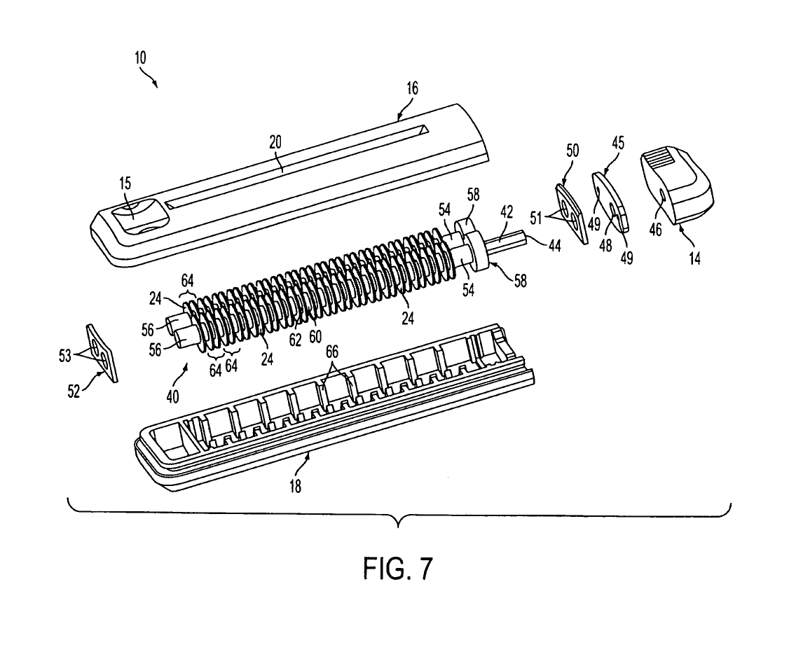

FIG. 1 depicts a perspective view of a hand-held shredding device 10 according to an embodiment of the present invention. The hand-held shredding device 10 may include a housing 12 and a crank or handle 14. The housing 12 may include a first member 16 and a second member 18 which may be permanently or removably coupled to one another. The first member 16 may include a first opening 20 which may be configured to receive an object (not shown) to be shredded or destroyed by a shredding assembly (not shown in FIG. 1) disposed within the housing 12. The shredding assembly is discussed in further detail below with reference to FIGS. 7-9. The object may be, for example, a paper document containing confidential or private information. The crank 14 may be rotatable relative to the housing 12 and may be arranged to be manually operable by a hand of a user (not shown in FIG. 1) to provide power to the shredding assembly to shred or destroy the object received through the first opening 20 in the housing 12. As shown in FIG. 1, the housing 12 may further include a gripping portion 15 which may be, for example, an indentation or recess disposed at an opposite end of the housing 12 from the crank 14 and configured to be gripped by the hand of the user during shredding.

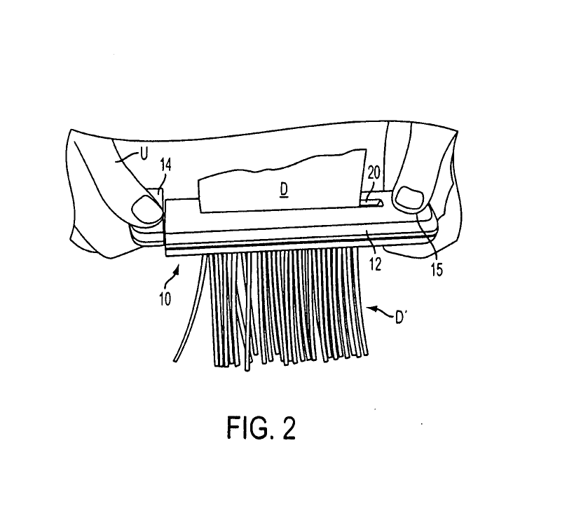

FIG. 2 depicts the hand-held shredding device 10 of FIG. 1 in use. The user U may grasp the hand-held shredding device 10 with one hand on the crank 14 and the other hand on the gripping portion 15. An object D such as, for example, a paper document containing confidential or private information may be inserted into the first opening 20. Once the object D is received in the first opening 20, the user 20 may rotate the crank 14 and thereby provide power to the shredding assembly (not shown) to move the object D through the housing 12 while simultaneously shredding or destroying the object D. As shown in FIG. 2, the modified object D′ may exit the housing 12 on a different side and in a shredded or destroyed state.

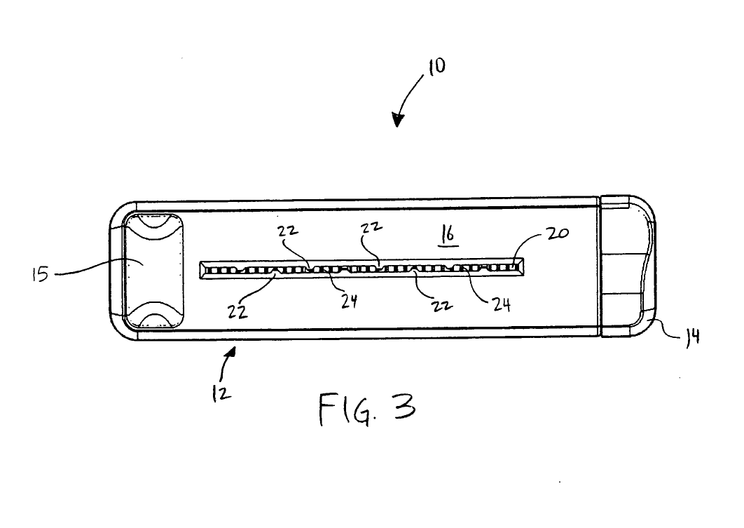

FIG. 3 depicts a top view of the hand-held shredding device 10 according to an embodiment of the invention. The first opening 20 in the housing 12 may extend longitudinally along the hand-held shredding device 10 between the crank 14 and the gripping portion 15. A periphery of the first opening 20 may include a plurality of protrusions 22 extending transversely into the first opening 20. The plurality of protrusions 22 may be formed integrally with the first member 16 of the housing 12 and may be arranged in an alternating fashion on the longitudinally extending edges defining the periphery of the first opening 20. The protrusions 22 may serve to bend or corrugate the object D upon receipt within the first opening 20 and thereby promote linear entry of the object D through the shredding assembly (not shown) by inhibiting longitudinal movement of the object D. The blades 24 of the shredding assembly can be seen in the embodiment depicted in FIG. 3.

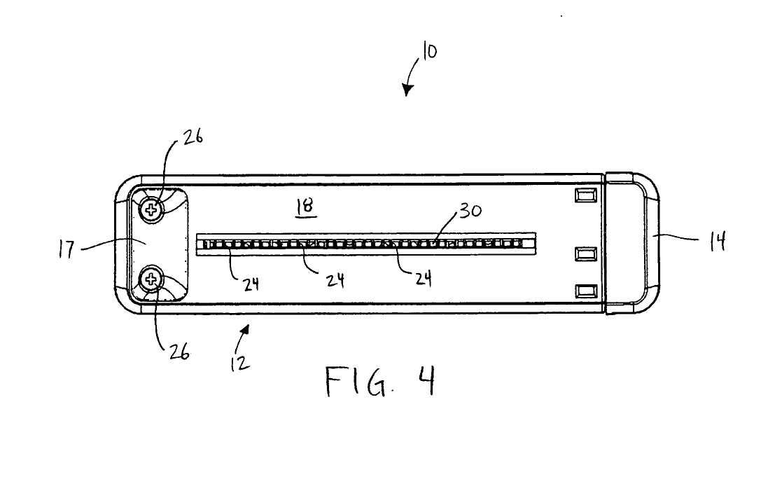

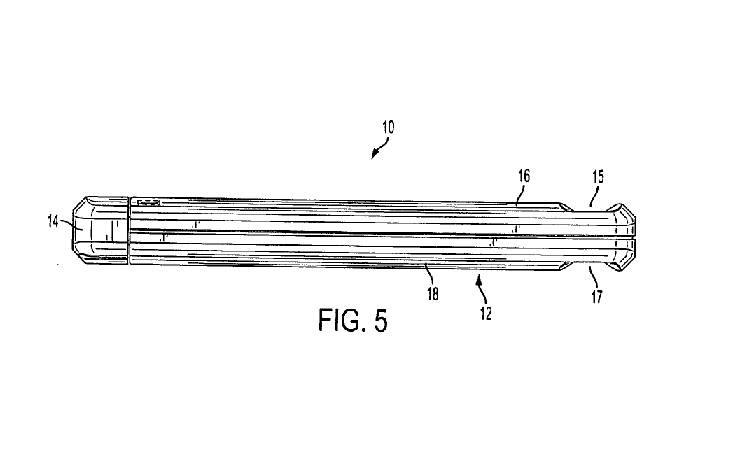

FIG. 4 depicts a bottom view of the hand-held shredding device 10 according to an embodiment of the invention. As shown in FIG. 4, the second member 18 of the housing 12 may include a second opening 30 through which the object D′ may exit after being shredded or destroyed by the blades 24 of the shredding assembly. The second opening 30 may be arranged on the housing 12 substantially opposite the first opening 20 such that the object D may have a substantially linear path through the housing 12. The second opening 30 may have substantially the same size and orientation as the first opening 20. The second member 18 may include a gripping portion 17 which may be, for example, an indentation or recess disposed at the same end of the housing 12 as the gripping portion 15 and configured to be gripped by the hand of the user during shredding. The gripping portion 17 may effectively mirror gripping portion 15 as shown in FIG. 5 which depicts a front view of the hand-held shredding device 10 of FIGS. 1-4. As shown in FIG. 4, a pair of fasteners 26 such as, for example, but not limited to, screws, may be inserted through the gripping portion 17 to secure the first and second members 16, 18 of the housing 12 together.

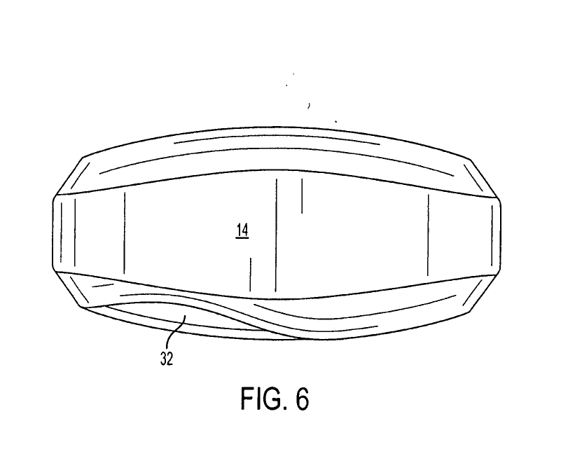

FIG. 6 depicts a side view of the hand-held shredding device 10 of FIGS. 1-5. As shown in FIG. 6, the crank 14 may include a curved or recessed portion 32 which may serve to provide an ergonomic gripping portion for a user's hand on the crank 14. The crank 14 may be formed in a variety of shapes and configurations as will be apparent to one of skill in the art. In general, the crank 14 may have a cross-section of substantially the same size and shape as the housing 12 to maintain a compact configuration such that the held shredding device 10 can be easily stowed, for example, in a bag, backpack, purse, or carry-on luggage.

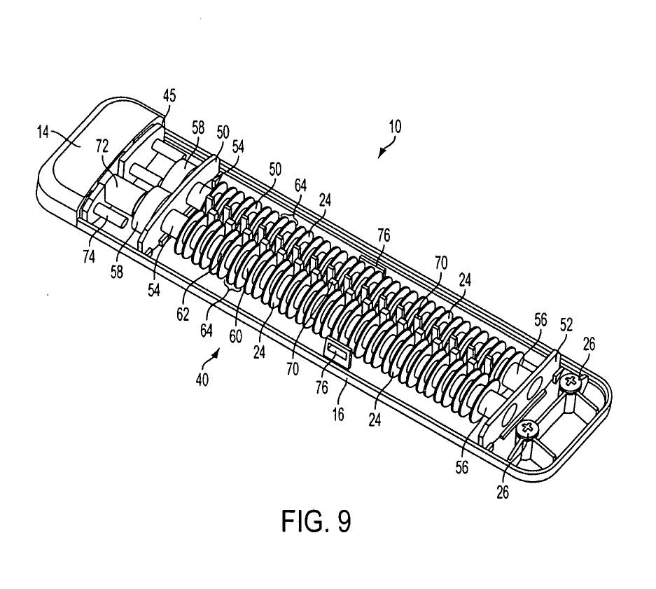

FIG. 7 depicts an exploded perspective view of the hand-held shredding device 10 of FIGS. 1-6. In addition to the above-mentioned features, the hand-held shredding device 10 may further include a shredding assembly 40 disposed within the first and second members 16, 18 of the housing 12 and configured to shred/destroy an object D received through the first opening 20. The second member 18 may have integrally formed reinforcing gussets 66 disposed along the inner walls thereof to add strength and rigidity to the housing 12 while allowing for decreased weight. The shredding assembly 40 may include at least two rotatable shafts 42 extending parallel to one another and longitudinally within the housing 12. An end 44 of one of the shafts 42 may be directly connected to the crank 14 such as, for example, by extending outside of the housing 12 through a housing connection plate 45 and being secured within an opening 46 in the crank 14. In this way, manual manipulation of the crank 14 by a user may provide direct power input to the at least one shaft 42 to shred the object D. The housing connection plate 45 may include a hole 48 through which the at least one shaft 44 may extend. The housing connection plate 45 may also include a plurality of additional holes for receiving fasteners (not shown in FIG. 7—see FIG. 9) for connecting the first and second members 16, 18 of the housing 12 to one another.

According to the embodiment depicted in FIG. 7, a first bearing plate 50 and a second bearing plate 52 may be positioned within the housing 12 to support to each of the first and second rotatable shafts 42. The first bearing plate 50 may include holes 51 sized and configured to receive and support a first pair of journal sleeves 54 disposed on the shafts 42. The second bearing plate 52 may include holes 53 sized and configured to receive and support a second pair of journal sleeves 56 disposed on an opposite end of the shafts 42. A pair of gears 58 may be fixedly secured on the shafts 42 in driving connection with one another so that the rotational power input to one shaft 42 by manual manipulation of the crank 14 may be transferred to the other shaft 42. Each of the shafts 42 may further include a plurality of axially spaced blades 24 disposed thereon. The shafts 42 may have, for example, a non-circular cross-section or a circular cross-section with a key-way such that each component disposed thereon (e.g., the journal sleeves 54, 56, the gears 58, the blades 24, and/or the spacers 60, 62) cannot rotate relative to the shaft 42. Alternatively, one or more of the components may be integrally formed on or permanently adhered to a respective shaft 42.

Each of the blades 24 may be spaced from an adjacent blade 24 by one of either a first spacer 60 or a second spacer 62. Each first spacer 60 may have a greater axial dimension than each second spacer 62 and the first and second spacers 60, 62 may be disposed along the shaft 42 in an alternating fashion separated in each instance by a blade 24. More specifically, each first spacer 60 may have an axial dimension greater than an axial dimension of one second spacer 62 combined with the thickness of two adjacent blades 24. For ease of reference, the combination of one second spacer 62 and two adjacent blades 24 shall be hereinafter termed a blade assembly 64. As between the parallel shafts 42 then, each blade assembly 64 on one of the shafts 42 may be axially offset from corresponding blade assemblies 64 on the other shaft 42 by a least the axial dimension of a blade assembly 64 plus the thickness of a blade 24. That is, the blade assemblies 64 on the two shafts 42 may effectively alternate along the longitudinal dimension of the device such that each blade assembly 64 on one shaft 42 may be aligned with a first spacer 60 on the other shaft 42. In this embodiment, a cutting edge of each of the plurality of blades 24 on one shaft 42 may overlap with the cutting edge of a blade 24 on the other shaft 42 on the outside of each blade assembly 64.

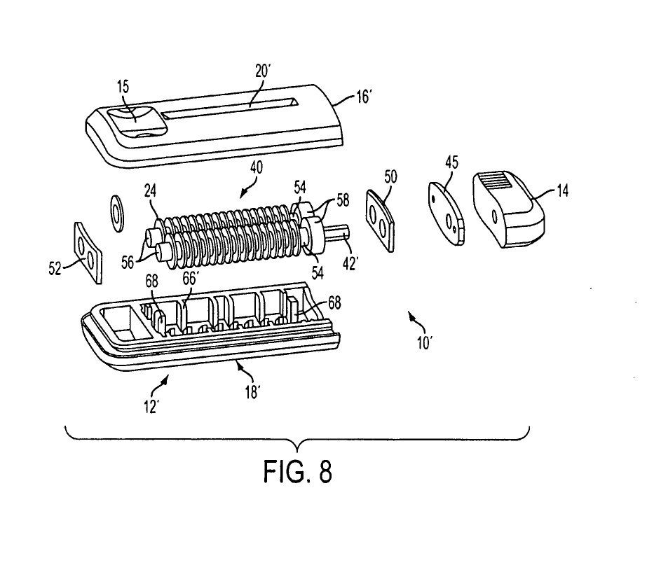

FIG. 8 depicts an exploded perspective view of a hand-held shredding device 10′ according to another embodiment of the present invention. The hand-held shredding device 10′ is substantially the same as the hand-held shredding device 10 according to the embodiment depicted in FIGS. 1-7 except that the device 10′ has a shorter overall longitudinal length and some other features. The device 10 depicted in FIGS. 1-7 may be, for example, sized to receive and shred larger objects D such as, for example, documents printed on standard sized paper (e.g., letter, legal, A4, etc.) even though folding may be required. Alternatively, the device 10′ may be sized to receive and shred smaller common objects D such as, for example, but not limited to, paper receipts and the like. As shown in FIG. 8, the first member 16′ of the housing 12′ may include a longitudinally smaller first opening 20′ relative to the first opening 20 in housing 12 above. Likewise, the second member 18′ of the housing 12′ and the shafts 42′ may be longitudinally shorter than second member 18 of the housing 12 and the shafts 42 described above. Additionally, the second member 18′ may include object support members 68 disposed at each end of the second opening 30′ (not shown in FIG. 8) and extending towards the first opening 20′ in the first member 16′. The object support members 68 may provide lateral support to an object D during shredding by the shredding assembly 40′.

FIG. 9 depicts a bottom perspective view of the hand-held shredding device 10 according to the embodiment shown in FIGS. 1-7 except that the second member 18 of the housing 12 is removed to show the shredding assembly 40 disposed within the housing 12. As shown in FIG. 9, the first member 16 may include a plurality of guide elements 70 extending from the area adjacent both longitudinal edges of the first opening 20 toward the second opening 30 in the second member 18 (not shown) and between the shafts 42 of the shredding assembly 40. More particularly, each guide element 70 may be a finger-like member extending between two adjacent blade assemblies 64 on a respective shaft 42, i.e., the space between two blades 24 defined by one of the first spacers 60. The guide elements 70 may serve to assist in keeping the object D in contact with the blades 24 during shredding as the object D passes through the device 10. As shown in FIG. 9, an additional journal sleeve 72 may also be disposed on the shaft 42 for rotary support within the hole 48 in the housing connection plate 45. A plurality of fasteners 74 may also be employed for connecting the first and second members 16, 18 of the housing 12 to one another at the end adjacent to the crank 14. Additionally, for purposes of securing the first and second members 16, 18 of the housing to one another, the first member 16 may further include a portion 76a of a snap-fit connection.

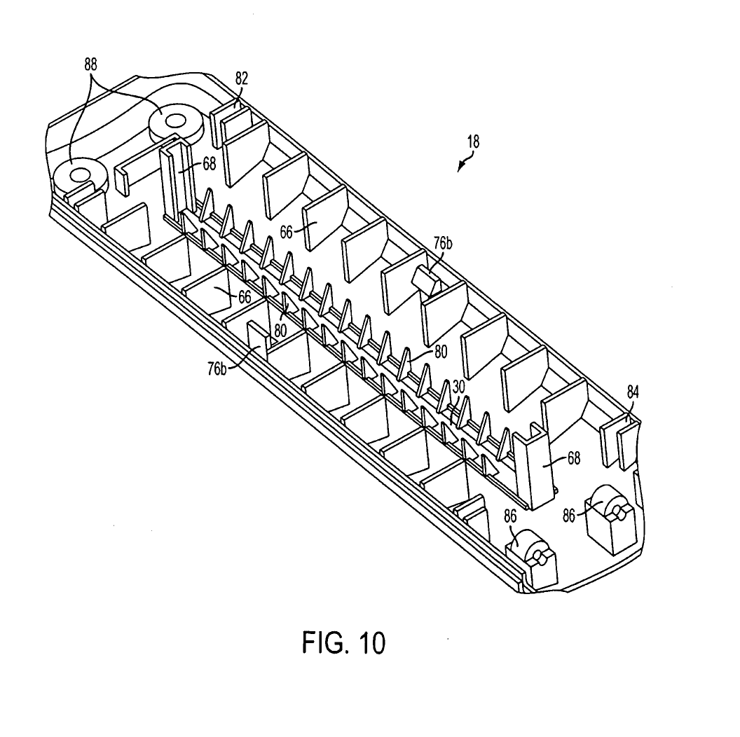

FIG. 10 depicts a top perspective view of the second member 18 of the housing 12 according to the embodiment shown in FIGS. 1-7 and 9. A plurality of second guide elements 80 may be disposed along the longitudinal edges of the second opening 30. Each of the second guide elements 80 may include an inclined surface configured to direct a shredded object D′ towards the second opening 30. The second member 18 may include at least one fastening support 86 for receiving the plurality of fasteners 74 (see FIG. 9) in order to connect the first and second members 16, 18 of the housing 12 to one another. Additionally, for purposes of securing the first and second members 16, 18 of the housing to one another, the second member 18 may further include a portion 76b which is configured to be coupled to the other portion 76a of the snap-fit connection. Holes 88 may be positioned on the second member 18 for receiving the fasteners 26. Also shown in FIG. 10 are the object support members 68 discussed in reference to the embodiment depicted in FIG. 8 as well as first and second receiving portions 82 and 84 which may be configured to receive and support the bearing plates 52 and 50, respectively.

While various embodiments of the present invention have been described above, it should be understood that they have been presented by way of example only, and not limitation. Thus, the breadth and scope of the present invention should not be limited by any of the above-described embodiments, but should instead be defined only in accordance with the following claims and their equivalents.

What is claimed is:

1. A hand-held shredding device comprising:
a housing sized and configured to be hand-held and including a first opening configured to receive an object to be shredded and a second opening configured to allow the object to exit the housing upon being shredded;
a shredding assembly disposed within the housing and comprising a first plurality of blades disposed on a first rotatable shaft and a second plurality of blades disposed on a second rotatable shaft, wherein the first and second rotatable shafts are coupled to one another through a geared connection and the first and second pluralities of blades are arranged to cooperate with one another to shred the object; and
a hand-operable crank connected to an end of one of the first or second rotatable shafts of the shredding assembly, wherein the hand-operable crank is configured to be operable by a user's hand to rotate one of the first or second rotatable shafts and thereby provide power to the shredding assembly to contemporaneously shred the object while moving the object towards the second opening.

2. The hand-held shredding device according to claim 1, wherein a periphery of the first opening includes a plurality of protrusions arranged to contact the object when the object is received in the first opening.

3. The hand-held shredding device according to claim 2, wherein the plurality of protrusions are alternatingly arranged on opposite longitudinally extending edges of the first opening.

4. The hand-held shredding device according to claim 1, further comprising a plurality of guide elements extending towards the second opening to guide and support the object during shredding.

5. The hand-held shredding device according to claim 4, wherein the plurality of guide elements are disposed adjacent to the first opening and extend substantially towards the second opening between the first and second rotatable shafts.

6. The hand-held shredding device according to claim 5, wherein each of the plurality of guide elements are positioned between two adjacent blades disposed on one of the first or second rotatable shafts.

7. The hand-held shredding device according to claim 4, further comprising a second plurality of guide elements positioned adjacent to the second opening to guide the object towards the second opening after shredding.

8. The hand-held shredding device according to claim 7, wherein each of the second plurality of guide elements includes an inclined surface arranged to guide the object towards the second opening after shredding.

9. The hand-held shredding device according to claim 7, wherein the second plurality of guide elements are integrally formed on an inner surface of the second member of the housing.

10. The hand-held shredding device according to claim 4, wherein the plurality of guide elements are integrally formed on an inner surface of the first member of the housing.

11. The hand-held shredding device according to claim 1, wherein the housing defines a longitudinal dimension and two mutually orthogonal transverse dimensions, the hand-operable crank being arranged at an end of the housing along the longitudinal dimension.

12. The hand-held shredding device according to claim 11, wherein the first and second openings extend along the longitudinal dimension on opposite sides of the housing.

13. The hand-held shredding device according to claim 1, wherein each of the first plurality of blades is arranged to cooperate with one of the second plurality of blades to contemporaneously shred the object while moving the object towards the second opening.

14. The hand-held shredding device according to claim 13, wherein each of the first plurality of blades is longitudinally offset from the respective cooperating one of the second plurality of blades by at least a thickness of one of the blades.

15. The hand-held shredding device according to claim 1, wherein the housing comprises a first member and a second member, the first member and the second member configured to be secured to one another.

16. The hand-held shredding device according to claim 15, wherein the first and second members of the housing are secured to one another by fasteners, a detent connection, a latch connection, and/or some combination thereof.

17. The hand-held shredding device according to claim 1, wherein the first plurality of blades are integrally formed on the first rotatable shaft and the second plurality of blades are integrally formed on the second rotatable shaft.

18. The hand-held shredding device according to claim 1, wherein the first plurality of blades are removably secured on the first rotatable shaft and the second plurality of blades are removably secured on the second rotatable shaft.

19. The hand-held shredding device according to claim 1, wherein the hand-operable crank has a cross-sectional size and shape substantially identical to the housing.

20. The hand-held shredding device according to claim 1, wherein the housing includes an indented portion at a longitudinal end opposite the hand-operable crank.
